(19) United States
(12) Patent Application Publication
(10) Pub. No.: US 2026/0195881 A1
(43) Pub. Date: Jul. 9, 2026

(54) SCORE CALCULATION DEVICE, MICROSCOPE SYSTEM, SCORE CALCULATION METHOD, AND RECORDING MEDIUM

(71) Applicant: Evident Corporation, Tatsuno-machi (JP)

(72) Inventor: Kosuke TAKAGI, Kamiina-gun (JP)

(73) Assignee: Evident Corporation, Tatsuno-machi (JP)

(21) Appl. No.: 19/556,930

(22) Filed: Mar. 4, 2026

Related U.S. Application Data
(63) Continuation of application No. PCT/JP2025/018005, filed on May 19, 2025.

(30) Foreign Application Priority Data
May 20, 2024 (JP) 2024-081769

(51) Int. Cl. G06T 7/00; G06V 10/74; G06V 10/82

(52) U.S. Cl. CPC G06T 7/0002; G06V 10/761; G06V 10/82; G06T 2207/10056; G06T 2207/20084; G06T 2207/30168

(57) ABSTRACT

A score calculation device that calculates an image quality score of a microscopic image is provided with a processor. The processor acquires a generated image of a subject by inputting a microscopic image of the subject acquired using a microscope to an image generation model that outputs an output image with improved image quality from an input image, and calculates a score indicating similarity between the microscopic image and the generated image as an image quality score of the microscopic image.

### CROSS-REFERENCE TO RELATED APPLICATION

This application is a continuation of International Application No. PCT/JP2025/018005, filed May 19, 2025, which claims priority to Japanese Patent Application No. 2024-081769, filed May 20, 2024, the entire disclosures of which are incorporated herein by reference.

### FIELD

The disclosure of the present specification relates to a score calculation device, a microscope system, a score calculation method, and a recording medium.

### BACKGROUND

There is known a technology for assisting optimization of setting of a microscope parameter by a computer. For example, WO2019/106730A describes a calculation model that outputs an acquisition condition enabling the acquisition of an image with improved image quality by inputting an image and an acquisition condition of the image.

The calculation model described in WO2019/106730A uses a combination of an image, an acquisition condition of the image, and an acquisition condition enabling the acquisition of an image with improved image quality as teacher data. Therefore, it is necessary to know an appropriate setting of a microscope parameter at the learning stage, and a technology for assisting the setting of a microscope parameter by different approaches is desired due to a large burden imposed when the teacher data is created.

### SUMMARY

According to an aspect of the present invention, there is provided a score calculation device that calculates an image quality score of a microscopic image, including: a processor. The Processor acquires a generated image of a subject by inputting a microscopic image of the subject acquired using a microscope to an image generation model that outputs an output image with improved image quality from an input image; and calculates a score indicating similarity between the microscopic image and the generated image as an image quality score of the microscopic image.

According to an aspect of the present invention, there is provided a score calculation method for calculating an image quality score of a microscopic image, including: acquiring a generated image of a subject by inputting a microscopic image of the subject acquired using a microscope to an image generation model that outputs an output image with improved image quality from an input image; and calculating a score indicating similarity between the microscopic image and the generated image that has been acquired as an image quality score of the microscopic image.

According to an aspect of the present invention, there is provided a non-transitory computer-readable recording medium storing a program for causing a computer of a score calculation device that calculates an image quality score of a microscopic image to execute processing of: acquiring a generated image of a subject by inputting a microscopic image of the subject acquired using a microscope to an image generation model that outputs an output image with improved image quality from an input image; and calculating a score indicating similarity between the microscopic image and the generated image that has been acquired as an image quality score of the microscopic image.

### BRIEF DESCRIPTION OF THE DRAWINGS

FIG. 1 is a diagram illustrating a configuration of a microscope system according to a first embodiment.

FIG. 2 is a diagram showing an example of a functional configuration of a control device included in the microscope system according to the first embodiment.

FIG. 3 is a diagram illustrating a relationship between data related to assistance in setting a microscope parameter.

FIG. 4 is a diagram explaining a tendency of data depending on the setting of the microscope parameter.

FIG. 5 is a flowchart showing an example of setting assistance processing performed in the microscope system according to the first embodiment.

FIG. 6 is a diagram explaining a score function that is a function of laser power and a recommended setting.

FIG. 7 is a diagram illustrating the score function that is a function of laser power.

FIG. 8 is a diagram illustrating a damage function that is a function of laser power.

FIG. 9 is a diagram illustrating an efficiency function that is a function of laser power.

FIG. 10 is a diagram showing an example of a functional configuration of a control device included in a microscope system according to a second embodiment.

FIG. 11 is a flowchart showing an example of setting assistance processing performed in the microscope system according to the second embodiment.

FIG. 12 is a diagram showing an example of a functional configuration of a control device included in a microscope system according to a third embodiment.

FIG. 13 is a flowchart showing an example of setting assistance processing performed in the microscope system according to the third embodiment.

FIG. 14 is a diagram illustrating a hardware configuration of a computer for implementing the control device.

FIG. 15 is a diagram illustrating a functional form of a score function that is a function of a Z-position.

### DETAILED DESCRIPTION

### First Embodiment

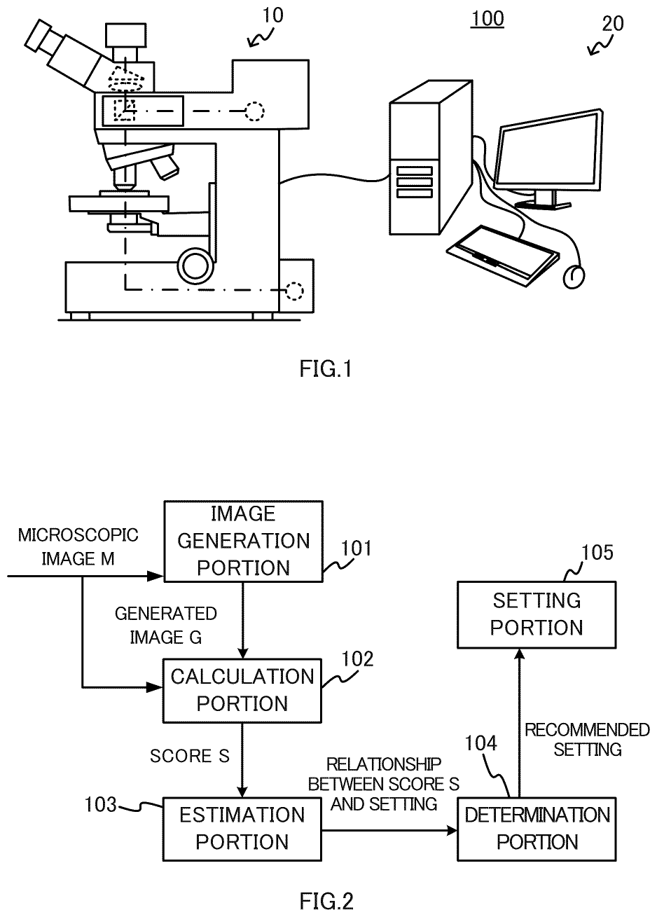

FIG. 1 is a diagram illustrating a microscope system according to an embodiment of the present invention. A microscope system 100 shown in FIG. 1 is a system that acquires a microscopic image of a subject, and is provided with a microscope 10 and a control device 20. The microscope 10 is not particularly limited as long as it is used to acquire a microscopic image of a subject. The control device 20 is a control device that controls the microscope 10 according to the setting of a microscope parameter, and is a computer including a processor and a memory.

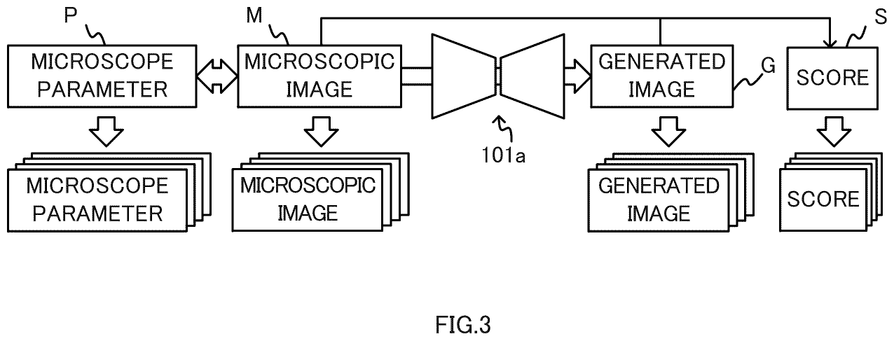

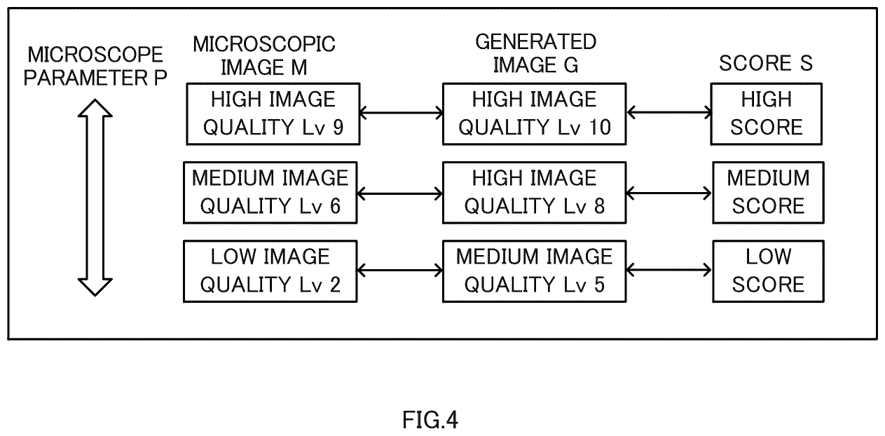

FIG. 2 is a diagram showing an example of a functional configuration of the control device 20 included in the microscope system 100. FIG. 3 is a diagram illustrating a relationship between data related to assistance in setting a microscope parameter P. FIG. 4 is a diagram explaining a tendency of data depending on the setting of the microscope parameter P. The above-described microscope system 100 is operated as a setting assistance system that assists the setting of the microscope parameter P by using a generation model.

The microscope parameter for which setting assistance is to be performed may be a parameter having an influence on the image quality of a microscopic image. In a case where the microscope 10 is a laser scanning microscope, the microscope parameter is not particularly limited, and includes, for example, laser power, an opening diameter of a confocal diaphragm, sensitivity of a detector, a Z-position of an objective lens, and the like. The microscope system 100 as a setting assistance system will be described below with reference to FIGS. 2 to 4.

The control device 20 is provided with an image generation portion 101, a calculation portion 102, an estimation portion 103, a determination portion 104, and a setting portion 105 shown in FIG. 2, which are implemented by the processor of the control device 20 reading a predetermined program into the memory and executing the program.

The image generation portion 101 is provided with a machine-learned image generation model 101a that outputs an output image with improved image quality from an input image. As shown in FIGS. 2 and 3, the image generation portion 101 inputs a microscopic image M of a subject acquired using the microscope 10 to the image generation model 101a, and outputs a generated image G generated by the image generation model 101a. The generated image G is an image of the same subject as the subject of the microscopic image M, and is an image in which the image quality of the microscopic image M of the subject is improved. The image quality improved by the image generation model 101a includes, for example, an SN ratio, contrast, resolution, and the like, but may also be evaluated by other indicators.

The image generation model 101a is, for example, an auto encoder that is one of unsupervised machine learning models, and can perform noise removal and the like by encoding the microscopic image M (input image), correcting feature quantity expressions, decoding the corrected feature quantity expressions, and outputting the generated image G (output image). However, the image generation model 101a of the image generation portion 101 is not limited to the auto encoder. The image generation model 101a may be, for example, another unsupervised machine learning model such as a variational auto encoder or a generative adversarial network, or may be, for example, a convolutional neural network (CNN)-based supervised machine learning model.

As shown in FIGS. 2 and 3, the calculation portion 102 calculates a score S corresponding to the microscopic image M (a score S of the microscopic image M) from the microscopic image M of the subject acquired using the microscope 10 and the generated image G of the subject acquired by inputting the microscopic image M to the image generation model 101a. The score S corresponding to the microscopic image M calculated by the calculation portion 102 is a score indicating similarity between the microscopic image M and the generated image G, and is, for example, a correlation coefficient calculated from the microscopic image M and the generated image G. However, the score S corresponding to the microscopic image M calculated by the calculation portion 102 is not limited to the correlation coefficient, and other scores indicating similarity between the images, for example, a mean square error (MSE), a peak signal-to-noise ratio (PSNR), cosine similarity, and the like may be used.

The microscope system 100 uses the score S indicating the similarity between the microscopic image M and the generated image G calculated by the calculation portion 102 as an index indicating the degree of optimization of the setting of the microscope parameter P. That is, the higher the similarity between the images indicated by the score S, the closer the setting of the microscope parameter P is to an optimized state in terms of image quality. For example, as in a case of the correlation coefficient, in a case where the higher the numerical value, the higher the similarity, the higher the score S, the closer the setting of the microscope parameter P is to an optimized state in terms of image quality. This is because, as shown in FIG. 4, when the microscopic image M itself input to the image generation model 101a has high image quality, there is a limit to the improvement in image quality and the extent of the improvement in image quality tends to be relatively small, whereas when the microscopic image M has low image quality, the improvement in image quality tends to be relatively large. That is, the score S is a score (hereinafter, also simply referred to as an image quality score) related to the image quality of the microscopic image M. The microscope system 100 assists the setting of a microscope parameter by using such features unique to the image generation model 101a, which have been newly found by the inventors of the present application.

The estimation portion 103 estimates a relationship between the score S corresponding to the microscopic image M and the setting of the microscope parameter P corresponding to the microscopic image M. The setting of the microscope parameter P corresponding to the microscopic image M is the setting of the microscope parameter P when the microscopic image M is acquired. For example, the estimation portion 103 may estimate the relationship between the score S and the setting of the microscope parameter P by using a score function that is a function of the microscope parameter P showing how the score S corresponding to the microscopic image M acquired by adjusting the setting of the microscope parameter P changes.

For example, the estimation portion 103 may assume a predetermined functional form for the score function, and approximate the score function with the predetermined functional form by using a plurality of scores S corresponding to a plurality of microscopic images M acquired by using the microscope 10 while changing the setting of the microscope parameter P and a plurality of settings of the microscope parameter P corresponding to the plurality of microscopic images M. As will be described later, the functional form for the score function is largely determined by the microscope parameter P to be set. Therefore, by determining the functional form based on the microscope parameter P and approximating the score function with the determined functional form, the estimation portion 103 can obtain the score function from a relatively small number of microscopic images M.

The determination portion 104 determines the recommended setting of the microscope parameter P based on the plurality of scores S corresponding to the plurality of microscopic images M acquired while changing the setting of the microscope parameter P and the plurality of settings of the microscope parameter P corresponding to the plurality of microscopic images M. Specifically, the determination portion 104 determines the recommended setting based on the relationship between the score S and the setting of the microscope parameter P estimated by the estimation portion 103. For example, the determination portion 104 may determine the recommended setting based on the relationship estimated from the score function. The recommended setting is the setting of the microscope parameter P corresponding to a maximum score S in a case where it is determined in terms of image quality. However, the setting corresponding to the maximum score S is not necessarily determined as the recommended setting. The determination portion 104 may determine the recommended setting by taking into account a factor other than the image quality, that is, the score S.

For example, in addition to the relationship between the score S and the setting of the microscope parameter P estimated by the estimation portion 103, the determination portion 104 may determine the recommended setting in consideration of a relationship between a score (referred to as a second score) different from the score S (image quality score) indicating the similarity between the images and the setting of the microscope parameter P. That is, the determination portion 104 may determine the recommended setting based on the relationship between the score S and the setting of the microscope parameter P estimated by the estimation portion 103 and the relationship between the second score and the setting of the microscope parameter P.

It is desirable that the score S is a quantification of image similarity, that is, image quality, whereas the second score relates to an evaluation item having a trade-off relationship with the image quality. Therefore, the determination portion 104 can determine the recommended setting while focusing on the image quality and striking a balance between the image quality and an evaluation item (for example, in general, time required for image acquisition, cost, damage to the subject, and the like) having a trade-off relationship with the image quality. The relationship between the second score and the setting of the microscope parameter P may be estimated based on a second score function that is a function of the microscope parameter P, which is created in advance using an actual measurement result, a simulation result, empirically known information, or the like.

The setting portion 105 updates the setting of the microscope parameter to the recommended setting determined by the determination portion 104. For example, when the determination portion 104 determines the recommended setting, the setting portion 105 may automatically update the setting of the microscope parameter to the recommended setting. In addition, after the determination of the recommended setting, the microscope system 100 may update the setting of the microscope parameter to the recommended setting when receiving an input of an instruction to apply the recommended setting from a user. For example, the microscope system 100 may once notify a user of the recommended setting itself determined by the determination portion 104 or that the recommended setting has been determined, and the setting portion 105 may set the recommended setting in the microscope system 100 in a case where the user who has confirmed the notified information permits a change to the recommended setting.

According to the microscope system 100 configured as described above, it is possible to assist the setting of the microscope parameter P by using the image generation model 101a. In particular, since the microscope system 100 adopts a mechanism of evaluating the setting of the microscope parameter P from the similarity between the microscopic image M and the generated image G generated using the image generation model 101a, there is no need to learn in advance the optimum setting (that is, parameter value) itself of the microscope parameter P. Therefore, it is not necessary to prepare the optimum setting of the microscope parameter P as teacher data, and it is possible to reduce the burden of preparation work at the stage of learning of the machine learning model (image generation model 101a). In addition, by adopting an unsupervised learning model as the image generation model 101a, any information in a state in which the setting of the microscope parameter P is optimized is not essential, and thus it is possible to further reduce the burden of preparation work at the learning stage.

The setting of the microscope parameter P is usually performed to acquire the microscopic image M having higher image quality. However, there are many cases where it is difficult to evaluate the image quality of the microscopic image M only from the microscopic image M. Regarding this, in the microscope system 100, the image quality is indirectly evaluated from the similarity between the images by focusing on the relationship between the similarity between the microscopic image M and the generated image G and the image quality, so that the image quality can be favorably evaluated even in a case where it is difficult to directly evaluate the image quality itself. Therefore, according to the microscope system 100, it is possible to assist the appropriate setting of the microscope parameter P by good image quality evaluation.

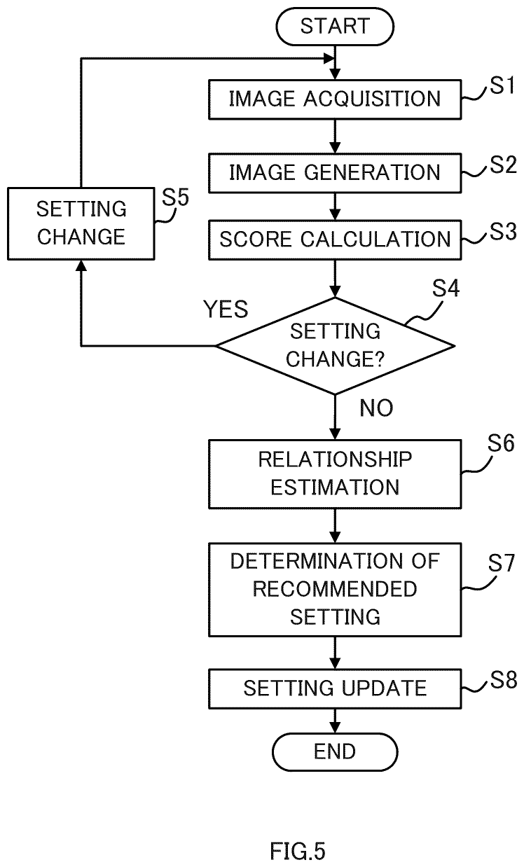

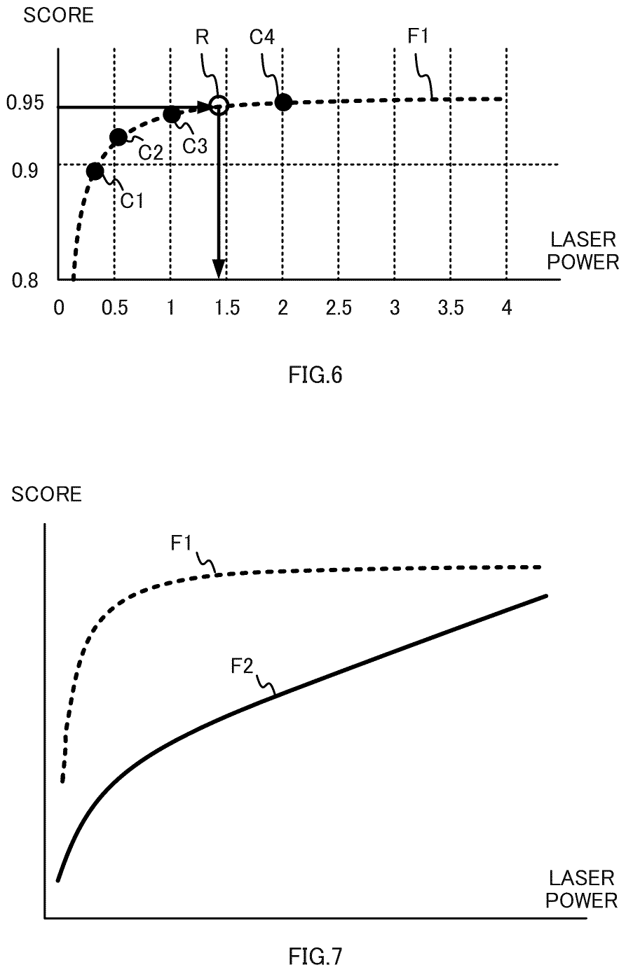

FIG. 5 is a flowchart showing an example of setting assistance processing performed in the microscope system 100. FIG. 6 is a diagram explaining a score function that is a function of laser power and the recommended setting. FIG. 7 is a diagram illustrating the score function that is a function of laser power. Hereinafter, the setting assistance processing performed in the microscope system 100 will be described in detail with reference to FIGS. 5 to 7.

The setting assistance processing shown in FIG. 5 that is performed using the setting assistance method according to the present embodiment is started by the processor of the control device 20 reading a predetermined program into the memory and executing the program. Here, assistance in setting the laser power of the microscope system 100 will be described as an example.

First, the processor of the control device 20 acquires the microscopic image M by controlling the microscope 10 according to the initial setting (Step S1). When acquiring the microscopic image M, the processor generates the generated image G by inputting the microscopic image M to the image generation model 101a (Step S2), and calculates the score S indicating image similarity based on the microscopic image M acquired in Step S1 and the generated image G generated in Step S2 (Step S3). Thereafter, the processor determines whether to change the setting of the microscope parameter P based on whether sufficient information for estimating the relationship between the score S and the setting of the microscope parameter P in Step S6 to be described later has been obtained (Step S4). Whether sufficient information for estimating the relationship has been obtained may be determined by, for example, whether image acquisition has been performed a predetermined number of times.

When determining that sufficient information for estimating the relationship has not been obtained (NO in Step S4), the processor changes the setting of the microscope parameter P (Step S5). In this example, the processor changes the laser power setting. Thereafter, the processor repeats the processing from Step S1 to Step S5 until it is determined that sufficient information for estimating the relationship has been obtained.

When determining that sufficient information for estimating the relationship has been obtained (YES in Step S4), the processor estimates the relationship between the score S and the setting of the microscope parameter P (Step S6) based on a plurality of the scores S obtained in Step S3 and the setting of the microscope parameter P corresponding to a plurality of the microscopic images M acquired in Step S1.

In Step S6, first, the processor determines a functional form of a score function F1 based on the microscope parameter P for which setting assistance is to be performed. In a case where the microscope parameter P for which setting assistance is to be performed is laser power, a logarithmic function may be assumed as the functional form. Thereafter, the processor approximates the score function F1 with the logarithmic function by using the plurality of scores S and the plurality of settings (laser power), and estimates a relationship between the score S and the setting of the microscope parameter P by using the score function F1. FIG. 6 shows a state in which a plurality of points (points C1 to C4) corresponding to a plurality of combinations of the score S and the laser power are plotted, and the score function F1 approximated with the logarithmic function is calculated from the plurality of points.

Even in a case where approximation is performed with the same logarithmic function, various score functions can be approximated depending on a combination of the score and the setting of the microscope parameter. For example, as shown in FIG. 7, a score function F1 in which the score is steeply increased with respect to the laser power and is stable at relatively low laser power, and a score function F2 in which the score is gently increased with respect to the laser power and does not stabilize until relatively high laser power is reached can be calculated.

When the relationship between the score and the setting of the microscope parameter is estimated, the processor determines the recommended setting (Step S7). In Step S7, the processor determines the recommended setting from the score function F approximated in Step S6. The recommended setting may be determined based on a predetermined criterion. For example, if a criterion is given that the score is 0.95 or more, the processor determines the minimum laser power at which the score is 0.95 or more as the recommended setting in order to obtain the image quality designated by the criterion while suppressing the damage to the subject as much as possible. In FIG. 6, a point R on the score function F1 where the score is 0.95 is shown, and it can be confirmed from the point R that the recommended setting is just under 1.5.

When the recommended setting is determined, the processor updates the setting of the microscope parameter to the recommended setting (Step S8). The update to the recommended setting may be performed after the input by a user who permits a change of the setting.

As described above, according to the microscope system 100 that performs the setting assistance processing shown in FIG. 5, it is possible to easily assist the setting of the microscope parameter by using the setting assistance method according to the present embodiment. In particular, it is possible to assist the setting of the microscope parameter such as laser power, whose relationship with image quality is generally difficult to quantitatively evaluate and that is often manually adjusted, and even a user who is unfamiliar with the microscope system can easily use the microscope system with an appropriate setting.

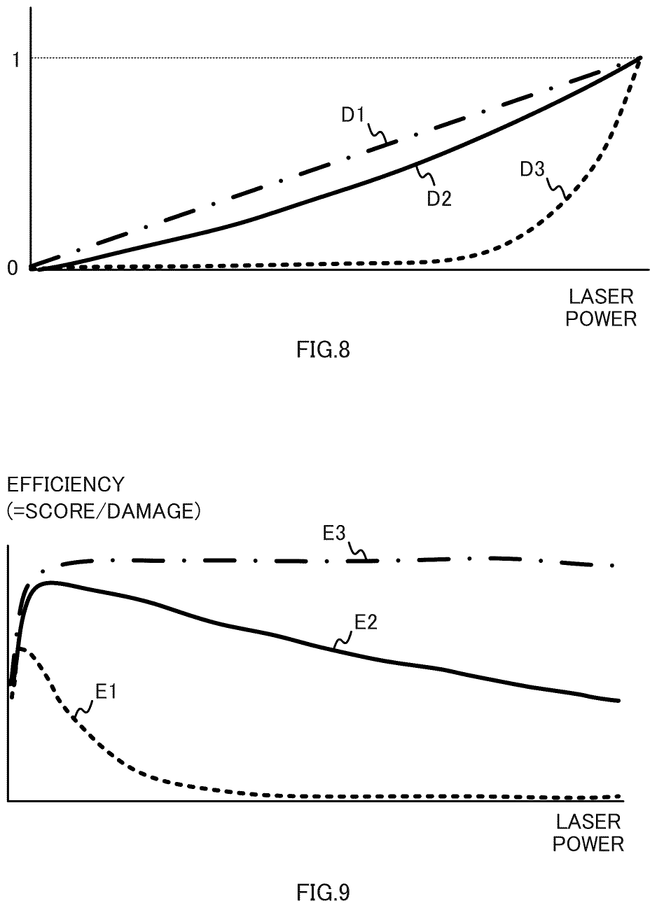

FIG. 8 is a diagram illustrating a damage function that is a function of laser power. FIG. 9 is a diagram illustrating an efficiency function that is a function of laser power. Hereinafter, modification examples of the setting assistance method according to the present embodiment will be described with reference to FIGS. 8 and 9.

The subject to be observed by the microscope system includes a subject that is easily damaged and a subject that is relatively hardly damaged. The determination portion 104 may determine the recommended setting in consideration of resistance to laser light that varies depending on the subject. In this case, as shown in FIG. 8, it is desirable to prepare in advance damage functions (damage functions D1 to D3) modeling the relationship between the laser power and the damage into several patterns, and to switch the damage function to be used according to the subject. Since a user himself/herself often knows whether the subject is likely to be damaged, it is desirable that the user can select the damage function to be used. However, the determination portion 104 may automatically select the damage function from the information of the subject.

When the damage function is selected, the determination portion 104 determines the recommended setting based on the score function and the damage function. For example, as shown in FIG. 9, the determination portion 104 may calculate efficiency functions (efficiency functions E1 to E3) showing the relationship between the score function and the damage function based on the score function and the damage function, and determine the recommended setting based on the efficiency function. The determination portion 104 may determine, as the recommended setting, a setting that is specified from the calculated damage function and with which the score can be most efficiently obtained with respect to the damage to the subject. Therefore, it is possible to determine, as the recommended setting, a setting achieving a high level of balance between image quality and suppression of damage in consideration of the characteristics of the subject. Although FIG. 9 shows an example in which the efficiency function is defined as score function/damage function, the definition of the efficiency function is not limited to this example.

### Second Embodiment

A physical configuration of a microscope system according to the present embodiment is the same as that of the microscope system 100 according to the first embodiment. While the microscope system 100 according to the first embodiment determines and sets the recommended setting of a microscope parameter by using the image generation model 101a, the microscope system according to the present embodiment is different from the microscope system 100 in that the setting of the microscope parameter by a user is assisted by providing the user with information showing the relationship between the score and the microscope parameter.

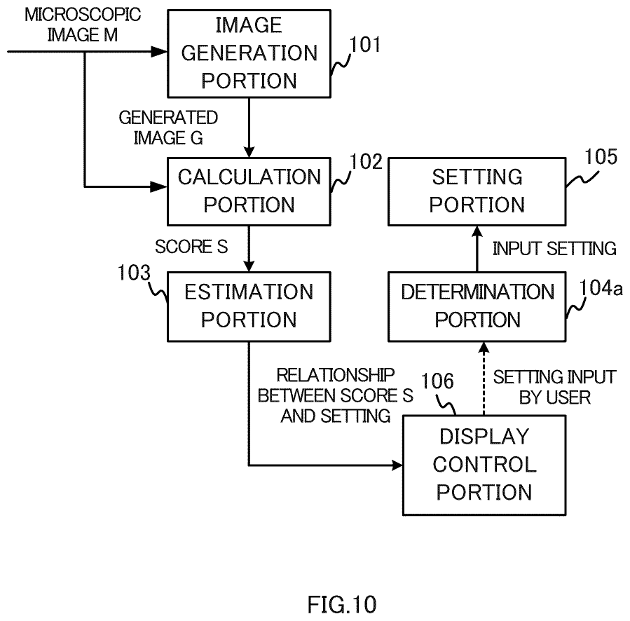

FIG. 10 is a diagram showing an example of a functional configuration of a control device included in the microscope system according to the present embodiment. The control device of the microscope system according to the present embodiment is provided with an image generation portion 101, a calculation portion 102, an estimation portion 103, a determination portion 104a, a setting portion 105, and a display control portion 106 shown in FIG. 10, which are implemented by a processor of the control device reading a predetermined program into a memory and executing the program.

The functional configuration of the present embodiment is different from the functional configuration of the first embodiment in that the determination portion 104a and the display control portion 106 are provided instead of the determination portion 104, but otherwise the same. The determination portion 104a detects the setting input by a user, and determines the setting as a microscope parameter to be set. The display control portion 106 causes a display device to display relationship information showing the relationship between the score and the setting of the microscope parameter. The display device is, for example, a display device provided in a control device 20, but not particularly limited thereto. The display device is not necessarily a display device included in the microscope system 100 as long as the user of the microscope system 100 can confirm the display device. For example, the display device may be a display device of a client terminal used by the user to access the microscope system 100.

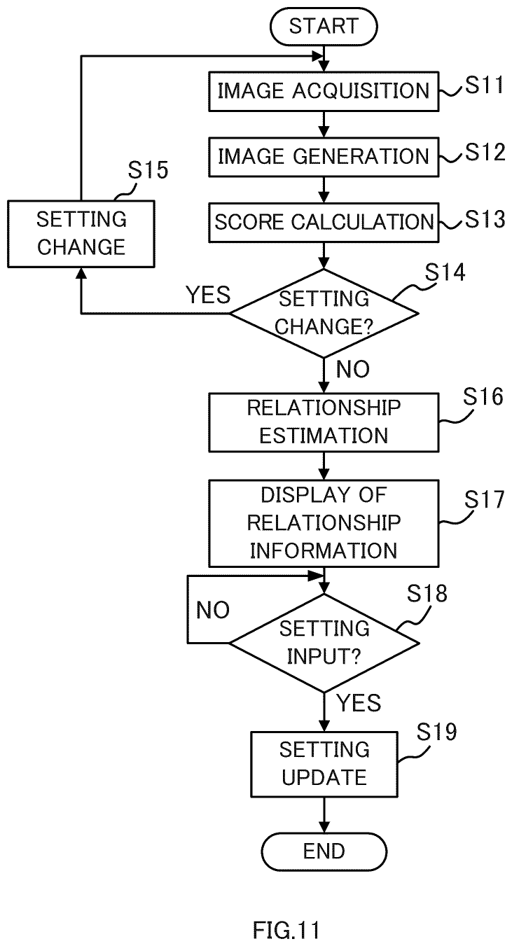

FIG. 11 is a flowchart showing an example of setting assistance processing performed in the microscope system according to the present embodiment. Hereinafter, the setting assistance processing performed in the microscope system according to the present embodiment will be described in detail with reference to FIG. 11.

The setting assistance processing shown in FIG. 11 that is performed using the setting assistance method according to the present embodiment is started by the processor of the control device 20 reading a predetermined program into the memory and executing the program. The processing from Step S11 to Step S16 is the same as the processing from Step S1 to Step S6 of the setting assistance processing shown in FIG. 5.

When the relationship between the score and the setting of the microscope parameter is estimated, the processor causes the display device to display relationship information (Step S17). In Step S17, the processor generates the relationship information based on the relationship estimated in Step S16, and causes the display device to display the relationship information. The relationship information is, for example, a score function. Specifically, the relationship information may show a score function in a graph form as shown in FIGS. 6 and 7, or show the relationship shown by the score function in a table form. Furthermore, in Step S17, the processor may cause the display device to display a damage function and an efficiency function in addition to or instead of the score function.

Thereafter, the processor monitors an input by the user regarding the setting of the microscope parameter (Step S18). When the user performs an input regarding the setting of the microscope parameter, the processor detects the input and updates the setting of the microscope parameter to the input setting (Step S19).

As described above, the setting of the microscope parameter can also be easily assisted by the microscope system that performs the setting assistance processing shown in FIG. 11. In particular, by displaying the relationship information on the display device to cause the user to recognize the relationship between a change of the setting and image quality, it is possible to appropriately assist the setting of the microscope parameter while leaving the final setting to the user. Therefore, for example, it is possible to flexibly handle a situation in which it is necessary to perform the setting in consideration of a factor other than image quality, and it is possible to assist the appropriate setting according to the situation. In addition, it is possible to provide a mechanism capable of assisting various users having different experiences from unfamiliar users to experienced users.

### Third Embodiment

A physical configuration of a microscope system according to the present embodiment is the same as those of the microscope systems according to the first and second embodiments. The microscope system according to the present embodiment is different from the microscope systems according to the first and second embodiments in that the microscope systems according to the first and second embodiments assist optimization of the setting of the microscope parameter, whereas the microscope system according to the present embodiment assists reproduction of the setting equivalent to or close to the setting of the microscope parameter when a target microscopic image is acquired.

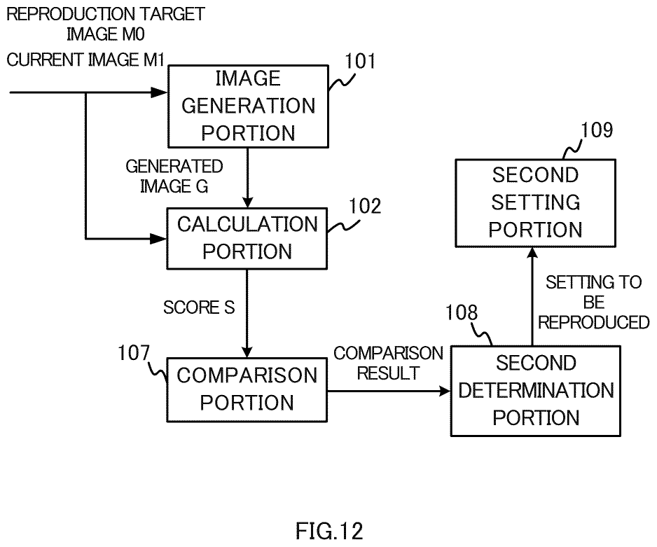

FIG. 12 is a diagram showing an example of a functional configuration of a control device included in the microscope system according to the present embodiment. The control device of the microscope system according to the present embodiment is provided with an image generation portion 101, a calculation portion 102, a comparison portion 107, a second determination portion 108, and a second setting portion 109 shown in FIG. 12, which are implemented by a processor of the control device reading a predetermined program into a memory and executing the program.

The functional configuration of the present embodiment is different from the functional configuration of the first embodiment in that the comparison portion 107, the second determination portion 108, and the second setting portion 109 are provided instead of the estimation portion 103, the determination portion 104, and the setting portion 105, but otherwise the same. The comparison portion 107 compares a score corresponding to the microscopic image acquired with the setting to be reproduced with a score corresponding to the microscopic image acquired with the current setting. The second determination portion 108 determines the setting to be reproduced based on the comparison result. The second setting portion 109 updates the setting of the microscope parameter to the determined setting.

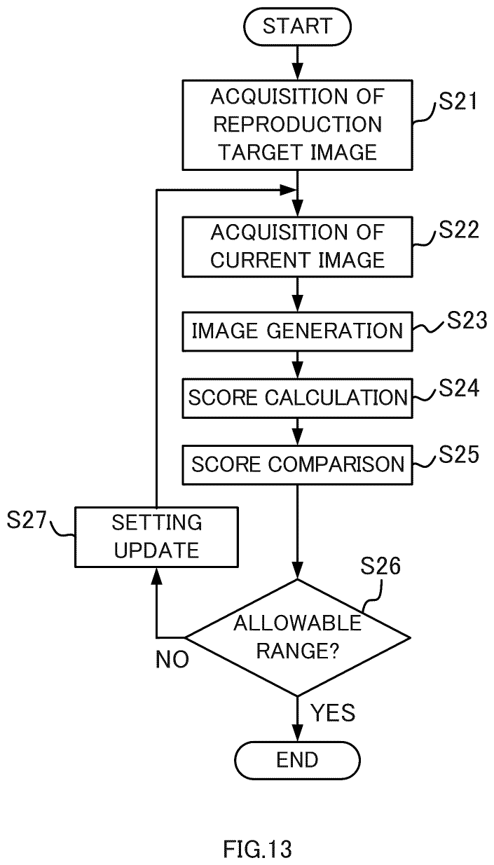

FIG. 13 is a flowchart showing an example of setting assistance processing performed in the microscope system according to the present embodiment. Hereinafter, the setting assistance processing performed in the microscope system according to the present embodiment will be described in detail with reference to FIG. 13.

The setting assistance processing shown in FIG. 13 that is performed using the setting assistance method according to the present embodiment is started by a processor of a control device 20 reading a predetermined program into a memory and executing the program. First, the processor acquires a microscopic image (hereinafter, referred to as a reproduction target image M0) acquired with the setting to be reproduced (Step S21). Furthermore, the processor acquires a microscopic image (hereinafter, referred to as a current image M1) by controlling a microscope 10 with the current setting (Step S22).

Next, the processor inputs the reproduction target image M0 and the current image M1 as input images to an image generation model 101a, and generates generated images G as output images (Step S23). Furthermore, the processor calculates scores indicating similarity between each of the input images and each of the output images (Step S24). That is, a score corresponding to the reproduction target image M0 and a score corresponding to the current image M1 are calculated.

Thereafter, the processor compares the scores (Step S25), and determines whether the comparison result is within a predetermined allowable range (Step S26). When it is determined that the comparison result is not within the allowable range (NO in Step S26), the processor updates the setting of the microscope parameter so as to approach the setting when the reproduction target image M0 is acquired (Step S27). Then, the processor repeats the processing from Step S22 to Step S26 until it is determined that the comparison result is within the allowable range (YES in Step S26).

As described above, the setting of the microscope parameter can also be easily assisted by the microscope system that performs the setting assistance processing shown in FIG. 13. In particular, since the setting when the microscopic image is acquired can be reproduced from the microscopic image alone, it is possible to perform a reproductive experiment by using the reproduced setting. The subject of the reproduction target image M0 and the subject of the current image M1 are not necessarily the same. The microscope system may be used for a comparison experiment using different subjects. By acquiring microscopic images of different subjects with equivalent settings, the reliability in quantitative evaluation of the microscopic images can be improved.

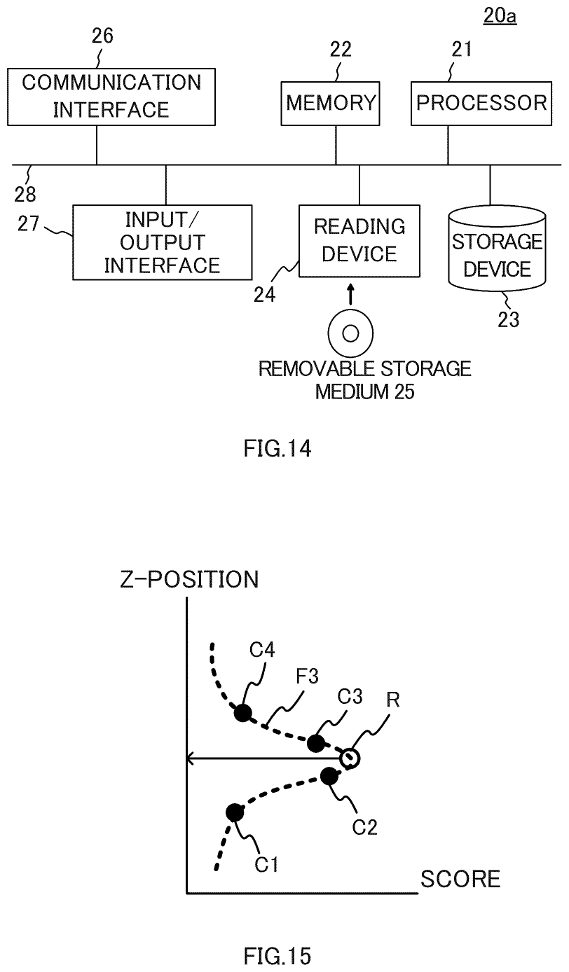

FIG. 14 is a diagram illustrating a hardware configuration of a computer 20a for implementing the control device 20 according to the above-described embodiment. The hardware configuration shown in FIG. 14 is provided with, for example, a processor 21, a memory 22, a storage device 23, a reading device 24, a communication interface 26, and an input/output interface 27. The processor 21, the memory 22, the storage device 23, the reading device 24, the communication interface 26, and the input/output interface 27 are connected to each other, for example, via a bus 28.

The processor 21 executes the control processing illustrated in FIGS. 5, 11, and 13, and the like by reading a program stored in the storage device 23 into the memory 22 and executing the program. The memory 22 is, for example, a semiconductor memory. The storage device 23 is, for example, a hard disk, a semiconductor memory such as a flash memory, or an external storage device.

The reading device 24 accesses a removable storage medium 25, for example, according to an instruction from the processor 21. For example, the removable storage medium 25 is implemented by a semiconductor device, a medium to/from which information is input/output by a magnetic action, a medium to/from which information is input/output by an optical action, or the like. For example, the communication interface 26 communicates with other devices (microscope 10 and the like) according to an instruction from the processor 21. The input/output interface 27 is, for example, an interface with a display device or an input device (not shown).

For example, the program executed by the processor 21 is provided to the computer in the following forms:
(1) installed in the storage device 23 in advance;
(2) provided by the removable storage medium 25; and
(3) provided from a server such as a program server.

Note that the hardware configuration of the computer for implementing the control device, described with reference to FIG. 14, is merely an example and the embodiments are not limited thereto. For example, a part of the above-described configuration may be removed or a new configuration may be added to the above-described configuration. Furthermore, in another embodiment, for example, some or all of the functions of the above-described control device may be implemented as hardware such as a field programmable gate array (FPGA), a system-on-a-chip (SoC), an application specific integrated circuit (ASIC), a programmable logic device (PLD), or the like.

The above-described embodiments are specific examples shown to facilitate understanding of the invention. The present invention is not limited to the above-described embodiments, and should be understood as including various modifications and alternative forms of the above-described embodiments. For example, it will be understood that the above-described embodiments can be embodied by modifying components without departing from the spirit thereof. In addition, it will be understood that various embodiments can be implemented by appropriately combining a plurality of components disclosed in the above-described embodiments. Furthermore, a person skilled in the art may understand that various embodiments may be implemented by removing some components from all the components described in the embodiments or adding some components to the components described in the embodiments.

In the above-described embodiments, an example has been described of assistance in setting laser power, but the microscope parameter to be set is not limited to the laser power. For example, focusing may be performed before setting the laser power, and the above-described setting assistance processing may be performed for a Z-position, which is a relative position between the objective lens and the subject, adjusted by focusing, as a microscope parameter to be set. A score function that is a function of the Z-position does not have a functional form of a logarithmic function unlike the case of laser power, and has a bell shape having a peak as shown in FIG. 15. Therefore, for example, the recommended setting may be determined by approximating the score function with the Gaussian distribution. In addition, the optimum setting may be determined by a method similar to general autofocus such as a so-called hill climbing method.

In the above-described embodiments, an example has been shown in which the microscope system 100 has the image generation model 101a, but the microscope system 100 only needs to be able to acquire a generated image generated by the image generation model 101a. Therefore, the microscope system 100 does not necessarily have the image generation model 101a, and the image generation model 101a itself may be placed outside the microscope system 100.

In the above-described embodiments, an example has been shown in which the control device 20 of the microscope system 100 calculates the score of the microscopic image in order to assist the setting of the microscope parameter, but the use of the calculated score is not limited to the assistance in setting the microscope parameter. The score of the microscopic image may be calculated for other applications, and may be calculated by a device different from the control device 20 of the microscope system 100. For example, the microscopic image may be input to an information processing device that is not connected to the microscope 10, and the information processing device may calculate the score of the microscopic image. That is, the information processing device is a score calculation device, and may be provided with: an acquisition portion that acquires a generated image of a subject by inputting a microscopic image of the subject acquired using a microscope to an image generation model that outputs an output image with improved image quality from an input image; and a calculation portion that calculates a score corresponding to the microscopic image indicating similarity between the microscopic image and the generated image acquired by the acquisition portion. The score calculation device may be the control device 20 of the microscope system 100. The score calculation device may have an image generation model, and in that case, the acquisition portion may acquire a generated image by inputting a microscopic image to the image generation model of the score calculation device. In addition, the score calculation device may have no image generation model, and in that case, the acquisition portion may transmit a microscopic image to a device having an image generation model that is different from the score calculation device to input the microscopic image to the image generation model, and acquire a generated image by receiving the generated image from the different device.

The present application claims priority based on Japanese Patent Application No. 2024-081769 filed in Japan on May 20, 2024, which is incorporated herein by reference in its entirety.

What is claimed is:

1. A score calculation device that calculates an image quality score of a microscopic image, the score calculation device comprising a processor configured to:
acquire a generated image of a subject by inputting a microscopic image of the subject acquired using a microscope to an image generation model that outputs an output image with improved image quality from an input image; and
calculate a score indicating similarity between the microscopic image and the generated image as an image quality score of the microscopic image.

2. A microscope system comprising:
the score calculation device according to claim 1; and
the microscope; wherein
the processor of the score calculation device is configured to:
determine, based on a plurality of image quality scores of a plurality of microscopic images acquired using the microscope while changing a setting of a microscope parameter that is a parameter of the microscope, the plurality of image quality scores being calculated, and a plurality of settings of the microscope parameter corresponding to the plurality of microscopic images, a recommended setting of the microscope parameter; and
update the setting of the microscope parameter to the recommended setting.

3. A microscope system comprising:
the score calculation device according to claim 1; and
the microscope; wherein
the processor of the score calculation device is configured to:
cause a display device to display relationship information that is estimated from a plurality of image quality scores of a plurality of microscopic images acquired using the microscope while changing a setting of a microscope parameter that is a parameter of the microscope, the plurality of image quality scores being calculated, and a plurality of settings of the microscope parameter corresponding to the plurality of microscopic images, and shows a relationship between the image quality score and the setting of the microscope parameter.

4. The microscope system according to claim 2, wherein
the processor is configured to estimate a relationship between the image quality score and the setting of the microscope parameter by using a score function that is a function of the microscope parameter approximated with a predetermined functional form using the plurality of image quality scores and the plurality of settings.

5. The microscope system according to claim 4,
wherein the processor is configured to determine the predetermined functional form based on the microscope parameter.

6. The microscope system according to claim 2,
wherein the processor is configured to determine the recommended setting based on a relationship between the image quality score and the setting of the microscope parameter estimated based on the plurality of image quality scores and the plurality of settings and a relationship between a second score and the setting of the microscope parameter, and
the second score is a score of the microscopic image regarding an evaluation item having a trade-off relationship with the image quality.

7. The microscope system according to claim 3,
wherein the processor is configured to cause the display device to display second relationship information showing a relationship among the image quality score, the second score, and the setting of the microscope parameter, and
the second score is a score of the microscopic image regarding an evaluation item having a trade-off relationship with the image quality.

8. The microscope system according to claim 2,
wherein the image generation model includes at least one of an auto encoder, a variational auto encoder, a generative adversarial network, and a convolutional neural network (CNN)-based supervised machine learning model.

9. The microscope system according to claim 2,
wherein the image generation model is an unsupervised learning model.

10. The microscope system according to claim 2, wherein
The processor is configured to update the setting of the microscope parameter based on a result of comparison between an image quality score of a microscopic image acquired with a setting of the microscope parameter to be reproduced and an image quality score of a microscopic image acquired with a current setting of the microscope parameter.

11. The microscope system according to claim 2,
wherein the score calculation device further has the image generation model, and
the processor is configured to acquire the generated image by inputting the microscopic image to the image generation model of the score calculation device.

12. The microscope system according to claim 2,
wherein the processor is configured to:
transmit the microscopic image to a device having the image generation model that is different from the score calculation device to input the microscopic image to the image generation model; and
acquire the generated image by receiving the generated image from the different device.

13. The microscope system according to claim 2,
wherein the processor is configured to determine the recommended setting of the microscope parameter by regarding the image quality score as a degree of optimization of the setting of the microscope parameter.

14. A score calculation method for calculating an image quality score of a microscopic image, the score calculation method comprising:
acquiring a generated image of a subject by inputting a microscopic image of the subject acquired using a microscope to an image generation model that outputs an output image with improved image quality from an input image; and
calculating a score indicating similarity between the microscopic image and the generated image that has been acquired as an image quality score of the microscopic image.

15. A non-transitory computer-readable recording medium storing a program for causing a computer of a score calculation device that calculates an image quality score of a microscopic image to execute processing of:
acquiring a generated image of a subject by inputting a microscopic image of the subject acquired using a microscope to an image generation model that outputs an output image with improved image quality from an input image; and
calculating a score indicating similarity between the microscopic image and the generated image that has been acquired as an image quality score of the microscopic image.
